(19) United States
(12) Patent Application Publication
(10) Pub. No.: US 2012/0059527 A1
(43) Pub. Date: Mar. 8, 2012

(54) Distributed Energy Storage System, and Applications Thereof

(75) Inventors: Virgil L. Beaston, Arlington, VA (US); Rodney G. Smith, Boca Raton, FL (US); Kevin D. Reid, Bethesda, MD (US)

(73) Assignee: GreenSmith Energy Management Systems, L.L.C., Bethesda, MD (US)

(21) Appl. No.: 13/127,967

(22) PCT Filed: Nov. 2, 2009
(86) PCT No.: PCT/US2009/062988

§ 371 Date: Nov. 17, 2011

Related U.S. Application Data
(60) Provisional application No. 61/111,650, filed on Nov. 5, 2008.

(51) Int. Cl. H02J 7/00; G06F 1/28; H01M 10/46

(52) U.S. Cl. 700/295; 320/134; 320/101; 713/320

(57) ABSTRACT

The present invention provides a distributed energy storage system, and applications thereof. In an embodiment, the distributed energy storage system includes power units, wherein each power unit has a multi-cell battery; a battery manager that monitors battery cell voltages and temperatures; and a controller. The controller provides a first control signal that causes the power unit to store energy in the battery and a second control signal that causes the power unit to generate an alternating current. A server in communication with each of the power units stores data collected from the power units about the batteries and analyzes the data to determine how much available energy is stored in the batteries that can be used to alter a load demand of a power network. In an embodiment, the batteries are lithium ion batteries capable of storing at least ten kilowatthours of energy.

### FIELD OF THE INVENTION

The present invention generally relates to energy management. More particularly, it relates to a distributed energy storage system, and applications thereof.

### BACKGROUND OF THE INVENTION

Electricity and the power networks used to transmit and distribute it are vital. Deregulation and shifting power flows, however, are forcing the power network to operate in ways it was never intended. In the United States, for example, the number of desired power transactions that cannot be implemented due to transmission bottlenecks continues to increase each year. This trend, along with a trend of increased electric power demand, has pushed the capacity of many transmission lines to their design limits. In some regions, the increase in electric power demand is such that periods of peak demand are dangerously close to exceeding the maximum supply levels that the electrical power industry can generate and transmit.

What are needed are new systems, methods, and apparatuses that allow the power network to be operated in a more cost effective and reliable manner.

### BRIEF SUMMARY OF THE INVENTION

The present invention provides a distributed energy storage system, and applications thereof. In an embodiment, the distributed energy storage system includes power units, wherein each power unit has a multi-cell battery; a battery manager that monitors battery cell voltages and temperatures; and a controller. The controller provides a first control signal that causes the power unit to store energy in the battery and a second control signal that causes the power unit to generate an alternating current. A server in communication with each of the power units stores data collected from the power units about the batteries and analyzes the data to determine how much available energy is stored in the batteries that can be used to alter a load demand of a power network. In an embodiment, the batteries are lithium ion batteries capable of storing at least ten kilowatt-hours of energy. In an embodiment, each power unit is coupled to a solar energy power source that is used to charge the power unit battery.

It is a feature of the distributed energy storage system of the present invention that it can be used to shift a utility's electrical power demand in time and thus present opportunities to reduce the cost paid for peak load power as well as reduce transmission congestion.

Further embodiments, features, and advantages of the present invention, as well as the structure and operation of various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram that illustrates various components of an example power network.

FIG. 2A is a diagram that illustrates an example regional load demand curve for a power network.

FIG. 2B is a diagram that illustrates using embodiments of the present invention to reduce the peak demand of the example regional load demand curve of FIG. 2A.

FIG. 3 is a diagram that illustrates an example power unit according to an embodiment of the present invention.

FIG. 4A is a diagram that illustrates various components of an example power unit according to an embodiment of the present invention.

FIG. 4B is a diagram that illustrates using a power unit according to an embodiment of the present invention with an example solar power source.

FIG. 5 is a diagram that illustrates an example controller according to an embodiment of the present invention.

FIG. 6A is a diagram that illustrates an example battery and current monitor according to an embodiment of the present invention.

FIG. 6B is a diagram that illustrates an example battery cell voltage monitoring setup according to an embodiment of the present invention.

FIG. 6C is a diagram that illustrates an example battery cell temperature monitoring setup according to an embodiment of the present invention.

FIG. 7 is a diagram that illustrates an example battery cell control card according to an embodiment of the present invention.

FIG. 8 is a diagram that illustrates using battery cell control cards to monitor and manage a battery according to an embodiment of the present invention.

FIG. 9 is a diagram that illustrates an example distributed energy storage system according to an embodiment of the present invention.

FIG. 10 is a diagram that illustrates using an example power unit to charge an electric vehicle according to an embodiment of the present invention.

The present invention is described with reference to the accompanying drawings. The drawing in which an element first appears is typically indicated by the leftmost digit or digits in the corresponding reference number.

### DETAILED DESCRIPTION OF THE INVENTION

The present invention provides a distributed energy storage system, and applications thereof. In the detailed description of the invention herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention provides a distributed energy storage system, and applications thereof. In an embodiment, the distributed energy storage system includes power units, wherein each power unit has a multi-cell battery; a battery manager that monitors battery cell voltages and temperatures; and a controller. The controller provides a first control signal that causes the power unit to store energy in the battery and a second control signal that causes the power unit to generate an alternating current. A server in communication with each of the power units stores data collected from the power units about the batteries and analyzes the data to determine how much available energy is stored in the batteries that can be used to alter a load demand of a power network. In an embodiment, the batteries are lithium ion batteries capable of storing at least ten kilowatt-hours of energy. In an embodiment, each power unit is coupled to a solar energy power source that is used to charge the power unit battery.

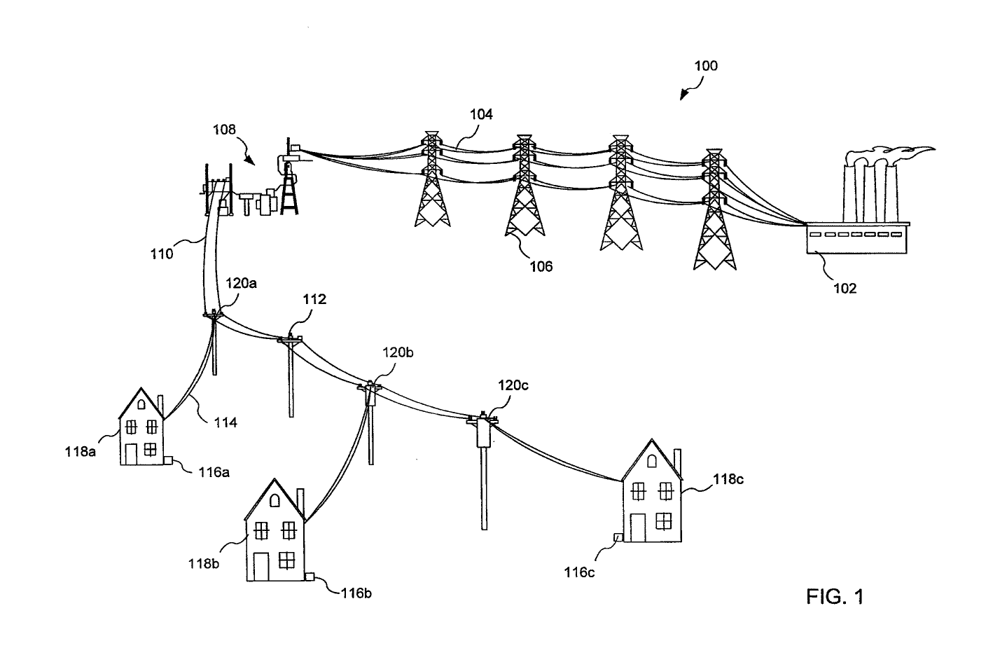

FIG. 1 is a diagram that illustrates various components of an example power network 100. Power network 100 illustrates how electrical power from one or more generating plants 102 is delivered to customers residing, for example, in houses 118a-c. The electrical power is transmitted from generating plant 102 to a substation 108 using high voltage transmission lines 104 supported by towers 106. At substation 108, the voltage of the electrical power is reduced and the electrical power is distributed to transformers 120a-c near houses 118a-c. The electrical power is distributed from substation 108 using distribution lines 110 supported by poles 112. At transformers 120a-c, the voltage of the electrical power is further reduced before being supplied to houses 118a-c. As described below, power units 116a-c are used, for example, to alter the load demand of power network 100.

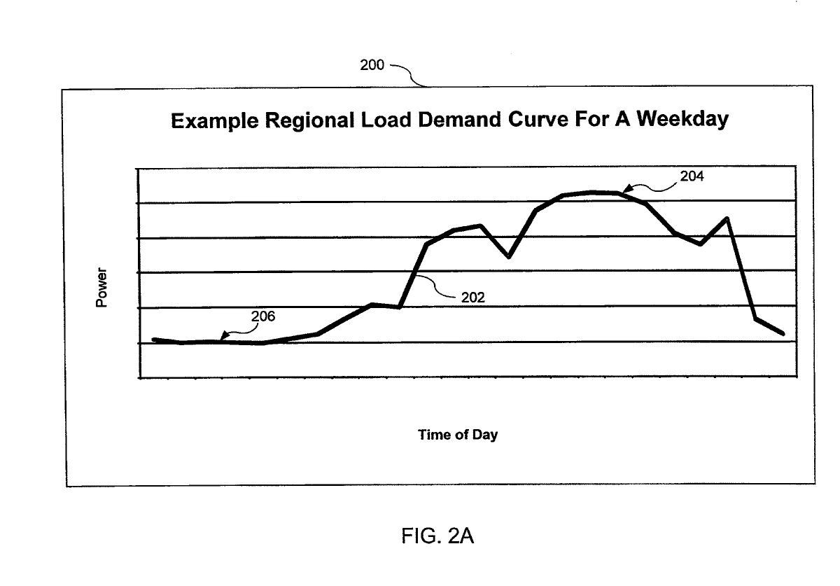

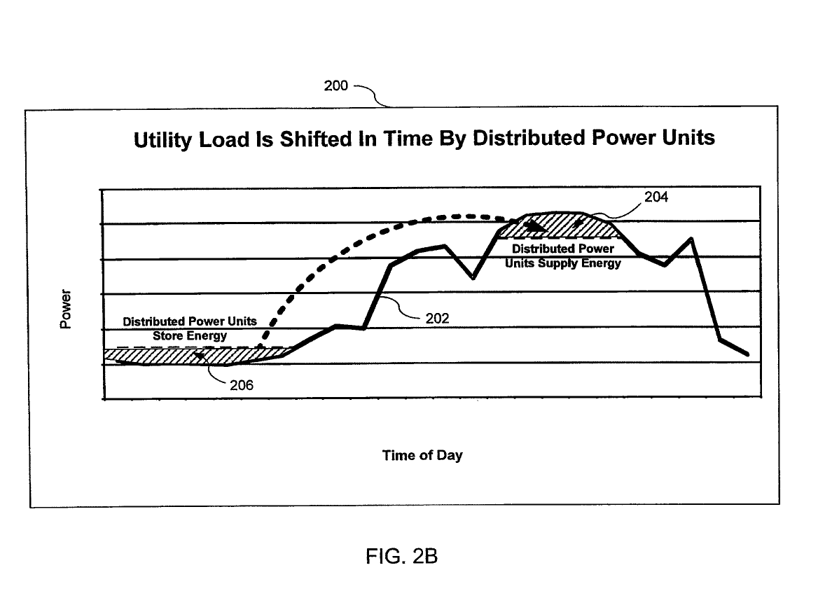

FIG. 2A is a diagram of a chart 200 that illustrates an example regional load demand curve 202 for a weekday for example power network 100. The regional power demand curve 202 has a peak demand 204. As shown in chart 200, the regional power demand for power network 100 is lowest at the time of day indicated by 206.

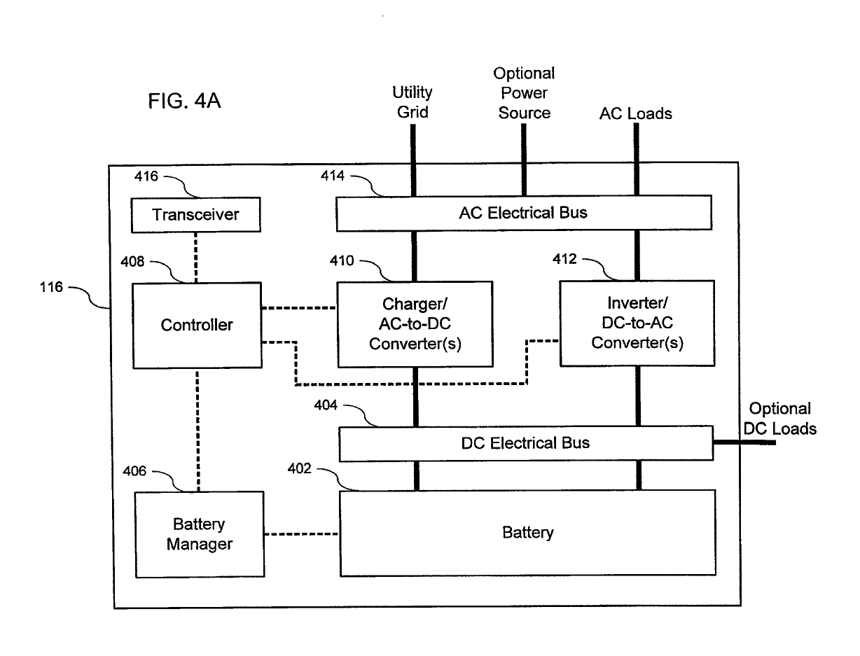

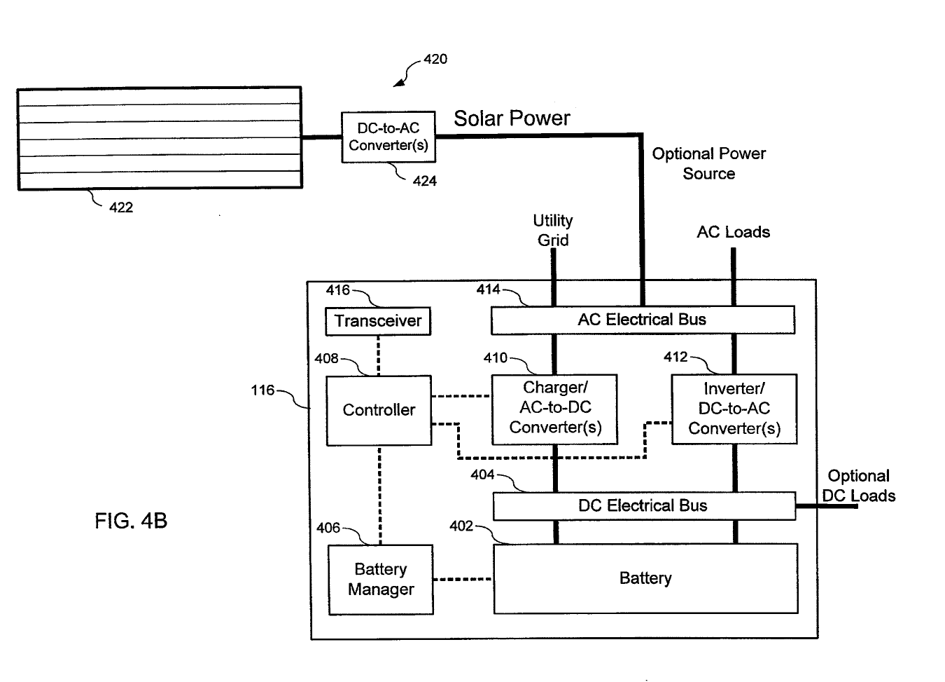

FIG. 2B is a diagram that illustrates using embodiments of the present invention to reduce the peak demand 204 of the example regional load demand curve 202. As shown in the chart, during the period of low power demand 206, power units 116 according to embodiments of the present invention store electrical energy in batteries (see, for example, FIG. 4A). As a result, a utility's power demand is increased above that represented by curve 202. During the periods of high power demand 204, power units 116 supply electrical energy stored in their batteries to household loads, for example, and thereby reduce the power demand represented by curve 202. Because the peak loads represented by curve 202 are reduced by the power units, a utility or transmission company can avoid starting up and running expensive, inefficient and/or certain polluting generating units that would otherwise be needed to meet the peak load demand. In addition, the use of power units 116 can delay and/or eliminate the need to build additional generating units and transmission lines.

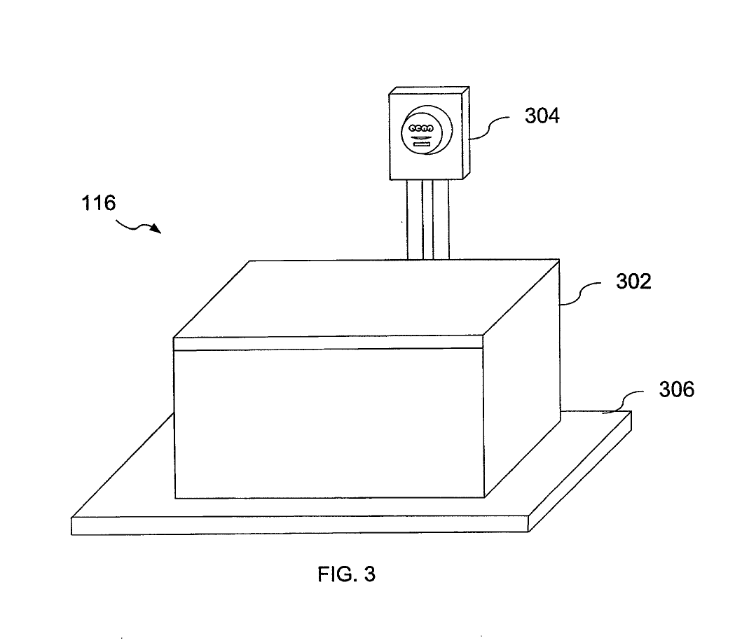

FIG. 3 is a diagram that further illustrates an example power unit 116 according to an embodiment of the present invention. As shown in FIG. 3, in an embodiment, a power unit 116 is enclosed in a rectangular enclosure 302. Power unit 116 is electrically connected to an electric meter 304. In an embodiment, power unit 116 is electrically connected upstream or on an utility side of electric meter 304, for example, if power unit 116 is owned by the utility and not the electricity customer. In another embodiment, power unit 116 is electrically connected downstream or on a customer side of electric meter 304, for example, if power unit 116 is owned by an electricity customer and not the utility supplying electricity to the customer. In one embodiment, power unit 116 rest and/or is coupled to a concrete slab 306. Enclosures other than the example rectangular enclosure illustrated in FIG. 3 can be used to enclose the components of a power unit according to the present invention. Enclosure 302 is selected and designed to protect the components of power unit 116 located inside of enclosure 302. The selection and design of enclosure 302 is based on the environment and expected conditions to which enclosure 302 may be subjected during its lifetime.

FIG. 4A is a diagram that illustrates various components of an example power unit 116 according to an embodiment of the present invention. As shown in FIG. 4A, in an embodiment, power unit 116 includes a battery 402, a DC electrical bus 404, a battery manager 406, a controller 408, a charger/AC-to-DC converter(s) 410, an inverter/DC-to-AC converter(s) 412, an AC electrical bus 414, and a transceiver 416.

Battery 402 can be any type of battery suitable for multiple charging and discharging cycles. In embodiments, battery 402 is preferably sized to supply 10 to 15 kilowatt-hours of electrical energy with a life expectancy of 3000 to 4000 charge and discharge cycles. Suitable batteries include, for example, the Thunder Sky lithium-ion batteries, which are available from Thunder Sky Energy Group Limited, whose address is Thunder Sky Industrial Base, No. 3 Industrial Zone, Lisonglang Village, Gongming Town, Bao'an District, Shenzhen, P.R.C, 5181016 (see http://www.thunder-sky.com). Other batteries are also suitable and can be used.

DC electrical bus 404 electrically couples battery 402 to charger/AC-to-DC converter(s) 410 and to inverter/DC-to-AC converter(s) 412. In embodiments, the charger and the inverter may be combined in a single charger-inverter unit, for example, to reduce costs. In a charger-inverter unit, the same power electronics can be used for both charging battery 402 and for generating an alternating current from the energy stored in battery 402. In an embodiment, DC electrical bus 404 is used to supply power to optional DC loads. DC electrical bus 404 can also be used to couple battery 402 to a source of DC power that is used to charge battery 402.

Battery manager 406 monitors the cells of battery 402 and prevents the cells from being over-charged and over-discharged. In embodiments, as described in detail below, battery manager 406 balances the cells of battery 402 and operates the cells of battery 402 in a manner that makes battery 402 have an extended lifetime. In embodiments, battery manager 406 monitors the voltage and temperature of each battery cell of battery 406 and the current of battery 406. These monitored parameters are used by battery manager 406 to control the state of charge and the state of health of battery 406.

Controller 408 controls the operation of power unit 116. As shown in FIG. 4A, controller 408 is electrically coupled to and exchanges control and/or information signals with battery manager 406, charger/AC-to-DC converter(s) 410, inverter/DC-to-AC converter(s) 412, and transceiver 416. In an embodiment, as illustrated for example in FIG. 4C, controller 408 receives various input information and makes determinations about when electrical energy supplied by a utility grid or an optional power source should be stored in battery 402 and when electrical energy stored in battery 402 should be supplied to AC loads, optional DC loads and/or sold back to the utility by way of the utility grid. In an embodiment, the information used by controller 408 to make these determinations includes information about battery 402 and information received by transceiver 416 regarding a desired charger operation time and a desired inverter operation time. Controller 408 is described in more detail below.

Charger/AC-to-DC converter(s) 410 receives AC power from AC electrical bus 414 and converts this power to DC power that is used to charge battery 404. The sizing of charger/AC-to-DC converter(s) 410 is dependent on the energy storage capacity of battery 402. In an embodiment, charger/AC-to-DC converter(s) 410 is selected so that battery 402 can be charged at a rate of about 0.3 C. In other embodiments, a larger charging rate may be desirable and so charger/AC-to-DC converter(s) 410 should be sized accordingly. The operation of charger/AC-to-DC converter(s) 410 is controlled by controller 408. In an embodiment, information about the state of charger/AC-to-DC converter(s) 410 is provided to controller 408 and transmitted to a remote location by transceiver 416.

Inverter/DC-to-AC converter(s) 412 receives DC power from battery 402 and DC electrical bus 404 and converts this power to AC power that is supplied to AC electrical bus 414. The sizing of inverter/DC-to-AC converter(s) 412 is dependent on the energy storage capacity of battery 402. In an embodiment, inverter/DC-to-AC converter(s) 412 is selected so that the useful energy stored in a charged battery 402 can be supplied at a rate of about 0.3 C or during a period of about three hours. In other embodiments, a larger discharge rate may be desirable and so inverter/DC-to-AC converter(s) 412 should be sized accordingly. The operation of inverter/DC-to-AC converter(s) 412 is controlled by controller 408. In an embodiment, information about the state of inverter/DC-to-AC converter(s) 412 is provided to controller 408 and transmitted to a remote location by transceiver 416. In embodiments, inverter/DC-to-AC converter(s) 412 operates as a current source/grid-tied inverter.

AC electrical bus 414 couples charger/AC-to-DC converter(s) 410 and inverter/DC-to-AC converter(s) 412 to a utility grid power source, an optional power source and/or AC loads.

Transceiver 416 is used to transfer data to and from controller 408. Transceiver 416 can be any type of transceiver. In embodiments, transceiver 416 facilitates either wired or wireless communications between a remote location and controller 408.

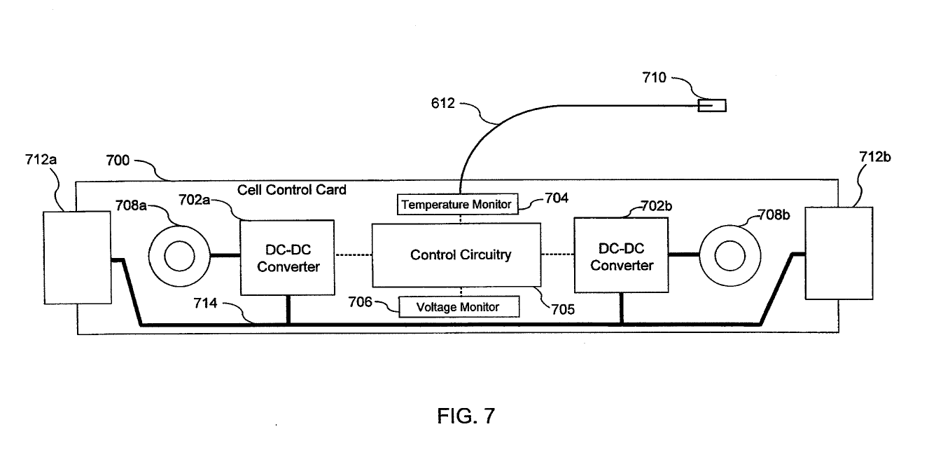

In an embodiment, battery manager 406 and controller 408 operate to manage the cells of battery 402 in the manner described in reference WO/2007/128876, titled “Method And Apparatus For The Management Of Battery Cells,” which is incorporated herein by reference in its entirety. As described therein, the battery manager and/or controller discover that one of the cells of battery 402 has a capacity higher than others during a charging or discharging process. Instead of just stopping the charging process as the weakest cell becomes fully charged, the most powerful cell is for example charged slightly more than the others. The result is that the most powerful cell sustains slight damage and its capacity decreases closer to other cells. The discharging process is indeed stopped whenever the voltage of even a single cell decreases too much, which means that in practice the discharge must always be stopped as determined by the cell of the lowest state of charge. However, this feature is counteracted by anticipation, wherein the weakest cell is supplied with some “virtual capacity” from all slightly more powerful cells, causing the weaker cell to discharge more slowly than the other cells. For example the charging can be made with 1% of the discharging current, resulting in a 99% discharge cycle as compared to other cells. The charging during the discharge cycle is lowering the stress of the cell and not actually charging the cell. The anticipation data is acquired by computing it from collected statistical data. Then, also in a subsequent discharge cycle, the weakest cell can be treated a bit more gently than the other cells, that is it is possible, for example, to transfer energy for assisting the weakest cell during the next discharge cycle by using a single cell's galvanically isolated charger (see for example FIG. 7) operating on the voltage of an entire battery. The weakest cell is saved also during the charge, that is, it is charged a bit less compared to its internal capacity. This can be done, for example, by charging with the other cells with 1% higher current or by bypassing part of the charging current by a resistor or by switched capacitor circuit.

Accordingly, in a subsequent or next charge and discharge cycle, the weakest cell is stressed slightly less than the others and the discrepancy evens out. In conventional battery management practices, the weakest cell is stressed in every cycle more than the others with respect to its capacity and thereby deteriorates even more. The method used in embodiments of the present invention, however, is easing the weaker cell both during charge and discharge. However, this is not a requirement of the present invention. In embodiments of the present invention, the battery manager and/or controller operate using collected history information, and they plan in advance the needed compensating measures. Conventional battery management systems do not take into account the capacity differences of cells when managing the depth of charge-discharge cycles, and at best they typically only control battery charging and discharging on the bases of cell voltage differences.

In embodiments, the battery manager and/or controller keep records of the charge, discharge, temperature, impedance and capacity, as well as other useful information, of each cell. For example, when a given cell has been intentionally overcharged, it can be expected to still have more charge than the others at the end of a subsequent discharge cycle. However, the difference in capacity is detectable over the very next cycle in the cell behavior. Accordingly, the particular cell can be discharged as required by the cell condition along with other cells for all of those to attain empty and full charge levels at the same time. Since some of the capacity of a single cell is intentionally discarded, it is advisable to keep management algorithms quite moderate to equalize properties of the cells little by little. The ultimate changes, which have an impact on the operation of battery 402, should be equalized at a very early stage of its life cycle. However, the operation and conditioning processes of cells can be continued for as long as power unit 116 is in service.

In embodiments, battery manager 406 and/or controller 408 track and keep records of the temperature of each cell of battery 402. As would be known to persons skilled in the relevant art(s) given the description herein, cell temperature can have a considerable effect on the cell behavior. Additional details regarding battery manager 406 and controller 408, as well as their operation, are provided below.

FIG. 4B is a diagram that illustrates using a power unit 116 according to an embodiment of the present invention with an example solar power source 420. As illustrated in FIG. 4B, example solar power source 420 includes solar panels 422 and DC-to-AC converters 424. Although FIG. 4B shows the optional power source as being a solar power source, the invention is not limited to just using a solar power source. Other sources of power such as a wind turbine, a micro turbine, a diesel generator, etc. can be used as will be understood by persons skilled in the relevant art(s) given the description herein. Sources of DC power can be connected to DC electrical bus 404 and also used. Thus, the present invention is not limited to just optional sources of AC power.

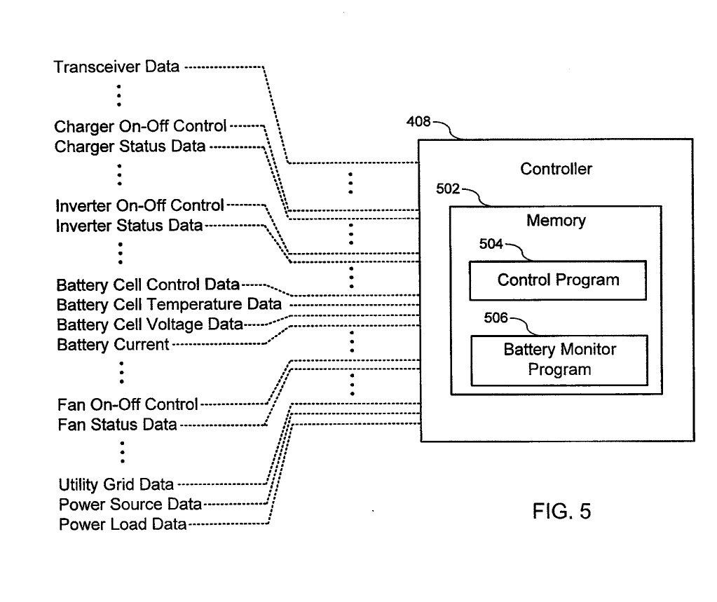

FIG. 5 is a diagram that further illustrates an example of a controller 408 according to an embodiment of the present invention. As shown in FIG. 5, controller 408 includes a memory 502 that has a control program 504 and a battery monitor program 506. In embodiments, controller 408 sends and/or receives some or all of the following data: transceiver data, which can include updates to control program 504 and battery monitor program 506; charger on-off control data; charger status data; inverter on-off control data; inverter status data; battery cell control data; battery cell temperature data; battery cell voltage data; battery current data; optional fan on-off control data; optional fan status data; utility grid data; optional power source data; and power load data.

In an embodiment, control program 504 controls the charging of battery 402 and the generation of AC power from the energy stored in battery 402. Control program 504 includes remotely programmable variables, for example, that allow a utility to control when battery 402 is charged and when AC power is produced, and thereby alter power demand for a power network such as power network 100 described above.

In an embodiment, battery monitor program 506 is responsible for implementing or assisting in the implementation of some or all of the features of the battery management functions described herein.

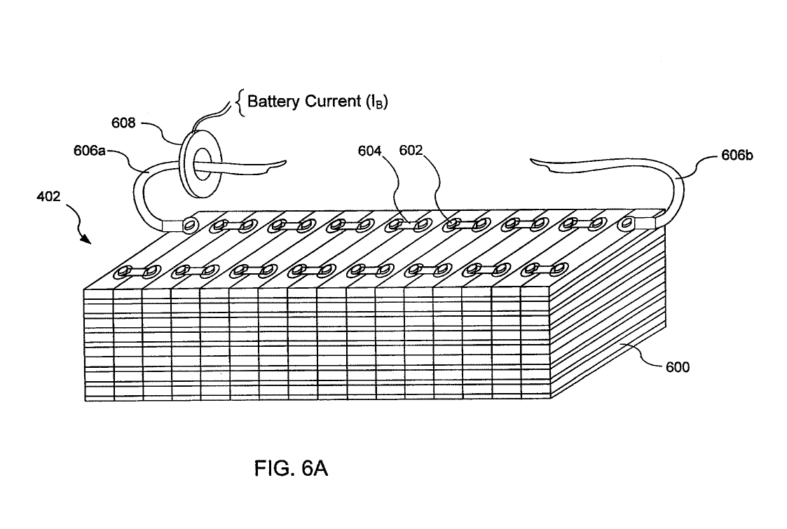

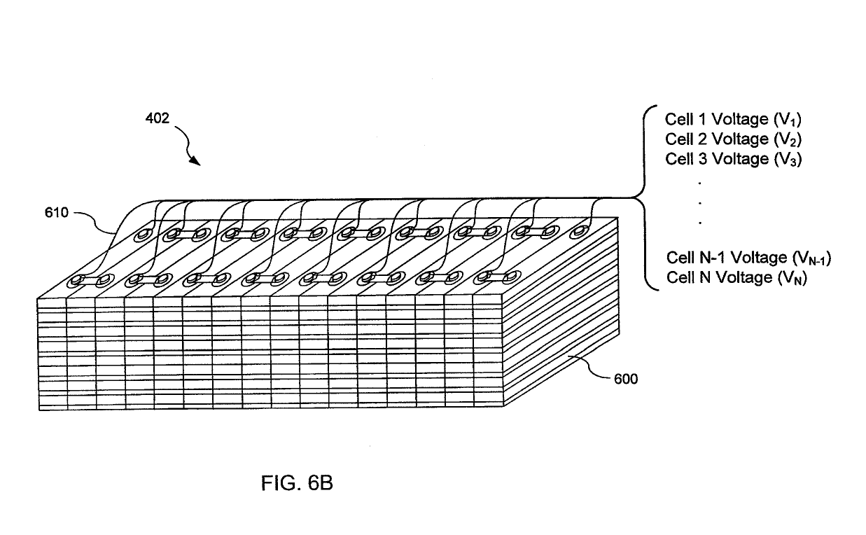

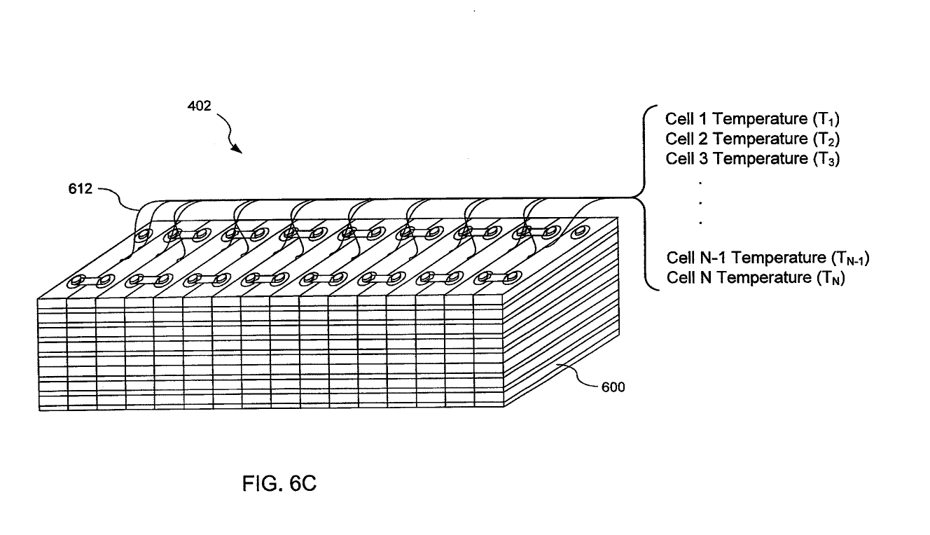

FIG. 6A is a diagram that further illustrates an example battery 402 and a battery current monitor 608 according to an embodiment of the present invention. As shown in FIG. 6A, battery 402 includes a plurality of battery cells 600 having poles 602. Each battery cell 600 includes a positive electrical pole and a negative electrical pole. The poles 602 of the cells 600 are connected together using pole connectors 604. In series connected cells, the positive pole of one battery cell is connected to the negative pole of an adjacent battery cell. Energy is provided to battery 402 and carried away from battery 402 using wires 606a-b. A current monitor 608 monitors the battery current (I_{B}). Any type of current monitor can be used so long as it is sufficiently accurate to be used in determining the state of charge of battery 402. In an embodiment, a highly accurate current shunt is used that can count the number of times one or more capacitors are charged and discharged and thereby accurately measure current.

FIG. 6B is a diagram that illustrates an example battery cell voltage monitoring setup 610 according to an embodiment of the present invention. As shown in FIG. 6B, the cell voltage monitoring setup 610 determines the cell voltage (V_{N}) of each battery cell 600 of battery 402.

FIG. 6C is a diagram that illustrates an example battery cell temperature monitoring setup 612 according to an embodiment of the present invention. As shown in FIG. 6B, the cell temperature monitoring setup 612 determines the cell temperature (T_{N}) of each battery cell 600 of battery 402.

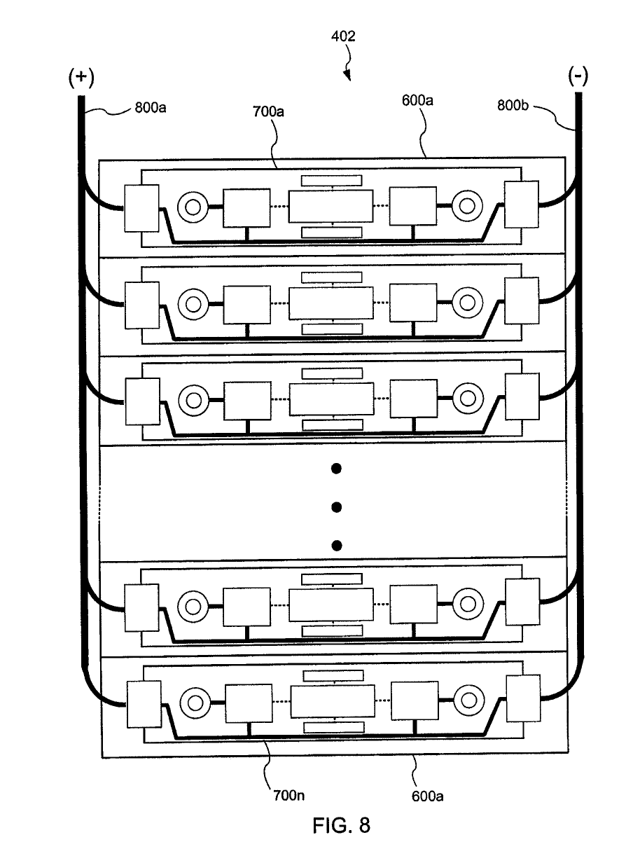

FIGS. 7 and 8 are diagrams that illustrate an example implementation of a battery manager 406 according to an embodiment of the present invention. FIG. 7 illustrates an example battery cell control card 700. FIG. 8 illustrates using a plurality of battery cell control cards 700a-n to monitor and manage a plurality of battery cells 600a-n.

As shown in FIG. 7, each battery cell control card 700 includes, for example, two DC-to-DC converters 702a-b, a temperature monitor 704 connected to a temperature sensor 710 by a wire 612, control circuitry 705, a voltage monitor 706, two connectors 708a-b for connecting the battery cell control card to the posts of a battery cell, and two control area network (CAN) connectors 712a-b. These various components are explained in more detail below.

As shown in FIG. 8, in an embodiment, a plurality of battery cell control cards 700a-n can be used to manage a battery 402 that has a plurality of cells 600a-n. The battery cell control cards are connected together and to controller 408 by wire bundles 800a-b. In an embodiment, the two CAN connectors 712a-b of each battery cell control card 700 are redundant, so only one CAN connector 712 need be connected to a wire bundle 800. The wire bundles 800 include both CAN data communication wires and power wires.

The cells 600a-n of battery 402 are monitored and controlled by control circuitry 705 of the battery cell control cards 700a-n. In an embodiment, the control circuitry 705 of each battery cell control card 700 may include an embedded central processing unit (CPU), which is in communication with controller 408. The CPUs collect information about the battery cells.

In an embodiment, during operation a galvanically isolated charger or power supply produces a direct current needed for charging the battery cells under control of controller 408 and control circuitry 705. The battery cells 600a-n are connected in series and through them passes a current from the power supply. Each battery cell control card 700 is in communication with one battery cell 600. The battery cell control cards 700a-n are linked by a communications network bus to each other and to controller 408, which enables controller 408 and control circuitry 705 to collect cell-specific information and to control management of each battery cell 600a-n. In communication with each battery cell control card 700 is a temperature sensor, a power converter, and a voltage monitor. Other instruments used for measuring cell properties can also be included. In an embodiment, the power converter acquires its current from the voltage of the entire battery 402 or directly from a power supply. The power converter is preferably galvanically isolated.

When the power converter is not connected and the system is in a discharge cycle, a charger in communication with the battery cell control cards can discharge the entire battery, if necessary, and charge an individual battery cell linked with the battery cell control cards 700. This enables, for example, providing a very high efficiency in battery equalization procedures during a discharge process. The difference between the charger and the energy derived from the cells is compensated for during a charging process by adjusting the output of the power supply. The controller and/or control circuitry executes compensatory calculations and controls the operation of all power converters.

In operation, during the course of a normal charging cycle, a regulated current and voltage for charging the cells of battery 402 is generated by a charger or power supply under the control of controller 408. The charging process is started for example by using a variable constant current and by monitoring operating parameters of the battery cells. After the voltages have risen close to the values of a fully charged cell, transition is made to an equalizing charge, as necessary. At this point, a variable current at a constant voltage is supplied by the charger or power supply, depending on the number of active power converters. Battery cell parameters are monitored by the battery cell control cards, and this information is continuously collected and sent to controller 408. The charging is controlled by controller 408 and/or control circuitry 705 in such a way that the current approaches zero after all power converters 702 have completed their charging/balancing functions.

In an embodiment, the operation of the battery cell control cards 700 is actively controlled by controller 408 to obtain a desired state of charge. Notable functions include, for example, a slight overcharge of one or more battery cells, a deep discharging of individual cells, and/or a discharge cycle proportionally higher or lower with respect to the true capacity of a cell.

In an embodiment, battery cell equalization can be performed with the power supply in operation or during a discharge cycle. By being able to charge and discharge a single battery cell in a controlled manner, battery manager 406 and controller 408 have the capability of decreasing or increasing the stress on particular battery cells during a charge, storage or discharge cycle. A cell-specific temperature measurement is performed in embodiments because the properties of a cell fluctuate as a function of temperature. Furthermore, the generation of heat provides information about the condition of a cell such as, for example, its internal series resistance. Charging a cell which is already fully charged results in the generation of a considerable heat power, which may potentially destroy the cell. Moreover, by monitoring individual battery cell temperatures, it is possible to provide a software-independent overheating protection, which overrides all other controls and opens the battery circuit.

In an embodiment, battery manager 406 and/or controller 408 can be used to measure the capacity of each battery cell accurately and to discharge each battery cell to a desired charge level using the power converters 702 and the charger/AC-to-DC converter(s) 410. Controller 408, for example, is capable of computing a joint current passing through battery 402 on the basis of information provided by the battery cell control cards, the charger, and the battery current monitor. In an embodiment, the battery current monitor is used for measuring a time integral of the current (i.e. a charge passing through the cells). Integration is effected, for example, either in the current monitor or is computed by controller 408. Each battery cell control card 700, for example, can be used for measuring or computing the current of a power converter 702, which is provided for example in parallel with the battery current, and the voltage across the poles of a battery cell, as well as other necessary parameters. The controller 408 is thus able to compute a joint capacity and efficiency for the battery cells using the monitored cell parameters. In addition, the discrepancies of each cell with respect to other cells can be computed from the monitored parameters and from the output of the battery current monitor. In practice, discrepancies may be generally measured more accurately than a joint capacity. This facilitates a precise equalization of the battery cells. As will be understood by persons skilled in the relevant art(s) given the description herein, the properties of an entire battery system are assessments at best, but the relative discrepancies between the battery cells of a battery can be measured with particular accuracy.

In an embodiment, the intentional overcharge of a battery cell stronger than others can be discharged during a discharging cycle to a greater depth than the others by having all other cells in a charging mode during the discharging cycle. In this case, the charge of a battery cell stronger than others will be exploited at a moderately high efficiency while other battery cells are in a charging process. Moreover, in an embodiment, the power converter associated with a battery cell stronger than others can be operated in a reverse sense during the discharging cycle. Hence, not only can inter-cellular discrepancies be equalized, but also the capacity of cells can be exhausted more thoroughly without neglecting to use any of the battery cells' capacity or without wasting energy.

In one embodiment, energy may be wasted for example by using just one voltage- or current-regulated joint charger and by dissipating outputs of the cells through resistances. In this case, battery cells can be bypassed in a charging process by using a low current for charging other cells or, instead of charging a single cell, by discharging the charge of all other cells for example by means of a resistance. Wasting energy may be more acceptable, for example, in the context of a solar-cell powered charger because of energy costs.

As will become apparent to persons skilled in the relevant art(s) given the description herein, the present invention functions very well using low cost/low quality electrical and electronic components as well as lower cost/lower quality batteries because of battery manager 406 and controller 408. Thus, the present invention offers significant benefits to electric utilities such as an ability to cost effectively alter their peak load demand by storing energy during off-peak electrical demand periods and by using the stored energy during periods of high demand instead of starting up and using higher cost generation units. The present invention can also be used to avoid grid congestion and to give utilities a means of cost effectively storing energy generated by clean energy power sources.

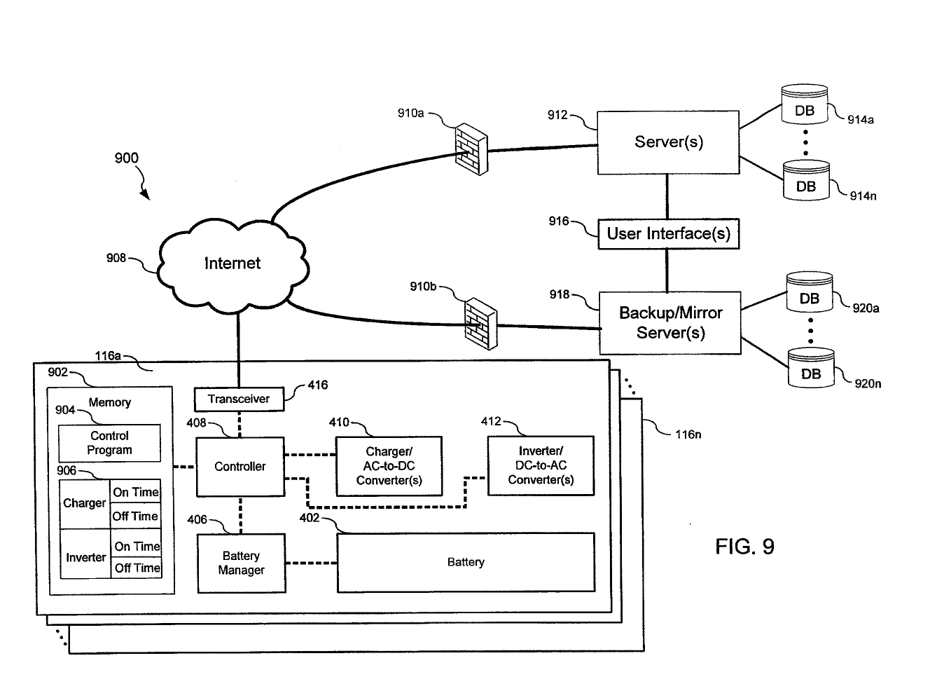

FIG. 9 is a diagram that illustrates an example distributed energy storage system 900 according to an embodiment of the present invention. As illustrated in FIG. 9, in an embodiment, system 900 includes a plurality of power units 16a-n that are in communication with one or more servers 912. The server(s) is shown communicating with power units 116a-n via the internet. Other means of communication are also possible such as, for example, cellular communications or an advanced metering infrastructure communication network. In an embodiment, system 900 may include one or more additional servers such as, for example, backup/mirror server(s) 918. Users of system 900 such as, for example, electric utilities and/or electric cooperatives interact with system 900 using user interface(s) 916. In an embodiment, the user interfaces are graphical, web-based user interfaces, for example, which can be accessed by computers connected directly to the servers or to the internet.

As shown in FIG. 9, server(s) 912 and server(s) 918 are protected by firewalls 910a and 910b, respectively. Server(s) 912 are in communication with data bases/storage devices 914a-n. Server(s) 918 are in communication with data bases/storage devices 920a-n.

In embodiments, user interface(s) 916 can be used to update and/or change programs and control parameters stored in a memory 902 of each power unit 116. This includes, for example, updating and/or changing a control program 904 and charger and inverter control variables 906 stored in a memory 902 of each power unit 116. By changing the control program and/or control parameters, a user can control the power units in any desired manner to alter the load demand of a power network such as, for example, power network 100. In an embodiment, the user interfaces can operate the power units to respond, for example, like spinning reserve and potentially prevent a major power brown out or black out.

In an embodiment, system 900 is used to learn more about the behavior of battery cells. Server(s) 912, for example, include logical and controlling modules that oversee the batteries of power units 116a-n and hold necessary information for controlling functions of the entire system 900. The system's server(s)/central processing units can be used, for example, for updating battery management algorithms for controlling the operation of the battery cells and for collecting and processing a considerable amount of information about the behavior of the entire system.

In an embodiment, information collected about the battery cells and operation of system 900 can be utilized by a manufacturer for example in neural networks or as material for an analysis conducted by statistical methods for developing a more effective future system. This telecommunication can also be used for varying algorithms in various units, for example, to increase the life of battery cells. Hence, in an embodiment, system 900 facilitates a research type environment that covers all power units that have been sold and which brings forth a more functional system to the benefit of all users and customers. For example, system 900 enables users to examine information collected and to determine how operating the batteries in a certain manner effects particular batteries and a predicted remaining service life of the batteries and system. Further features and benefits of system 900 will become apparent to persons skilled in the relevant art(s) given the description herein.

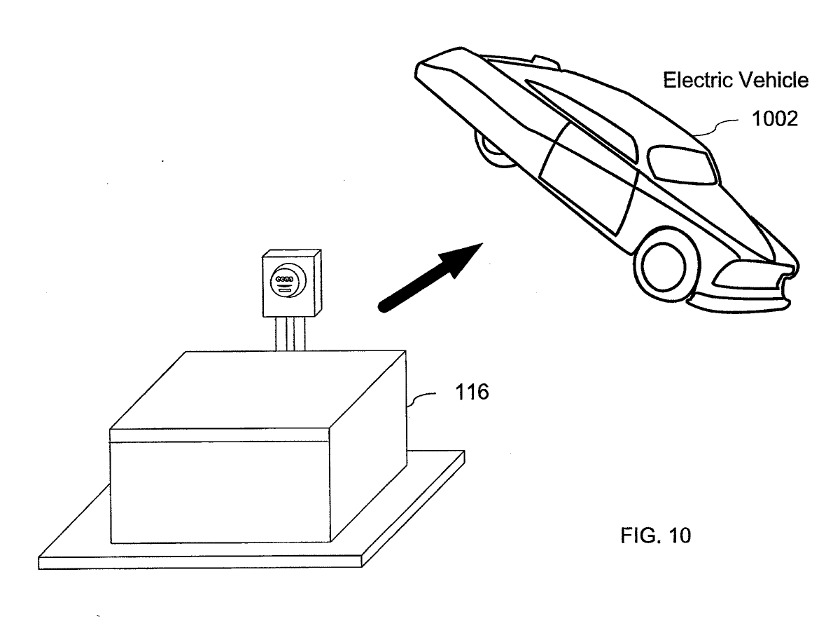

FIG. 10 is a diagram that illustrates using an example power unit 116 to charge an electric vehicle 1002 according to an embodiment of the present invention. Because of the location of the power unit, if it is deployed for example on a home owner's property, it is possible to use the power unit to recharge the batteries of electric vehicle 1002 using the energy stored in the batteries of the power unit. The power unit can be used, for example, to purchase electrical energy when prices are low and to store the energy until it is needed to recharge the batteries of the electric vehicle. This is particular advantageous when the energy being stored in the power unit comes from solar energy generated during the day, when the electric vehicle is not at home and available to be charged using the solar energy generated at the owner's home.

As will be understood by persons skilled in the relevant art(s) given the description herein, various features of the present invention can be implemented using processing hardware, firmware, software and/or combinations thereof such as, for example, application specific integrated circuits (ASICs). Implementation of these features using hardware, firmware and/or software will be apparent to a person skilled in the relevant art. Furthermore, while various embodiments of the present invention have been described above, it should be understood that they have been presented by way of example, and not limitation. It will be apparent to persons skilled in the relevant art(s) that various changes can be made therein without departing from the scope of the invention.

It should be appreciated that the detailed description of the present invention provided herein, and not the summary and abstract sections, is intended to be used to interpret the claims. The summary and abstract sections may set forth one or more but not all exemplary embodiments of the present invention as contemplated by the inventors.

What is claimed is:

1. A distributed energy storage unit, comprising:
a battery having a plurality of cells;
a battery manager, coupled to the battery, that monitors battery cell voltages and battery cell temperatures; and
a controller coupled to the battery manager,
wherein the controller provides a first control signal that causes the distributed energy storage unit to store energy in the battery and a second control signal that causes the distributed energy storage unit to generate an alternating current.

2. The distributed energy storage unit of claim 1, wherein the battery is a lithium ion battery capable of storing at least ten kilowatt-hours of energy.

3. The distributed energy storage unit of claim 1, wherein the battery manager includes a plurality of battery cell control cards that have dc-to-dc converters, and wherein the battery cell control cards adjust the amount of energy stored in individual cells of the battery.

4. The distributed energy storage unit of claim 3, wherein each battery cell control card periodically measures the impedance of an associated battery cell.

5. The distributed energy storage unit of claim 1, wherein the battery manager includes a current measuring device that is used to determine a state of charge of the battery.

6. The distributed energy storage unit of claim 1, further comprising:
a charger, coupled to the controller, that charges the battery in response to the first control signal; and
an inverter, coupled to the controller, that provides the alternating current in response to the second control signal.

7. The distributed energy storage unit of claim 1, further comprising:
a bidirectional converter, coupled to the controller, that charges the battery in response to the first control signal and that provides the alternating current in response to the second control signal.

8. The distributed energy storage unit of claim 1, wherein the controller includes a memory that stores a control program that determines a start time for charging the battery and a start time for providing the alternating current.

9. The distributed energy storage unit of claim 8, further comprising:
a transceiver coupled to the controller,
wherein data received by the transceiver is stored in the memory and used to alter at least one of the start time for charging the battery and the start time for providing the alternating current.

10. The distributed energy storage unit of claim 1, further comprising:
a solar energy power source coupled to the battery that is used to charge the battery.

11. The distributed energy storage unit of claim 1, further comprising:
a wind energy power source coupled to the battery that is used to charge the battery.

12. A distributed energy storage system, comprising:
a plurality of power units, wherein each power unit comprises
a battery having a plurality of cells,
a battery manager, coupled to the battery, that monitors battery cell voltages and battery cell temperatures, and
a controller coupled to the battery manager,
wherein the controller provides a first control signal that causes the distributed energy storage unit to store energy in the battery and a second control signal that causes the distributed energy storage unit to generate an alternating current; and
a server in communication with each of the power units, wherein the server stores data collected from the power units about the batteries and analyzes the data to determine how much available energy is stored in the batteries that can be used to alter a load demand of a power network.

13. The distributed energy storage system of claim 12, wherein the battery is a lithium ion battery capable of storing at least ten kilowatt-hours of energy.

14. The distributed energy storage system of claim 12, wherein the battery manager includes a plurality of battery cell control cards that have dc-to-dc converters, and wherein the battery cell control cards adjust the amount of energy stored in individual cells of the battery.

15. The distributed energy storage system of claim 12, wherein the battery manager includes a current measuring device that is used to determine a state of charge of the battery.

16. The distributed energy storage system of claim 12, further comprising:
a charger, coupled to the controller, that charges the battery in response to the first control signal; and
an inverter, coupled to the controller, that provides the alternating current in response to the second control signal.

17. The distributed energy storage system of claim 12, further comprising:
a bidirectional converter, coupled to the controller, that charges the battery in response to the first control signal and that provides the alternating current in response to the second control signal.

18. The distributed energy storage system of claim 12, wherein the controller includes a memory that stores a control program that determines a start time for charging the battery and a start time for providing the alternating current.

19. The distributed energy storage system of claim 18, further comprising:
a transceiver coupled to the controller,
wherein data received by the transceiver is stored in the memory and used to alter at least one of the start time for charging the battery and the start time for providing the alternating current.

20. The distributed energy storage system of claim 12, wherein each power unit further comprising:
a solar energy power source coupled to the battery that is used to charge the battery.
